(19) United States
(12) Patent Application Publication
(10) Pub. No.: US 2023/0279529 A1
(43) Pub. Date: Sep. 7, 2023

(54) MILL SHAFTS

(71) Applicant: AÇOFORJA INDUSTRIA DE FORJADOS S/A, Santa Luzia (BR)

(72) Inventor: Carlos Antonio COELHO, Palmares, Belo Horizonte (BR)

(21) Appl. No.: 18/005,525

(22) PCT Filed: Jul. 14, 2020
(86) PCT No.: PCT/BR2020/050258

§ 371 Date: May 11, 2023

(51) Int. Cl. C22C 38/46; C21D 9/28; C21D 6/00; C22C 38/44; C22C 38/04; C22C 38/02; C22C 38/00; C22C 38/42; B21K 1/10; C13B 10/06

(52) U.S. Cl. CPC C22C 38/46; C21D 9/28; C21D 6/002; C22C 38/44; C22C 38/04; C22C 38/02; C22C 38/002; C22C 38/42; B21K 1/10; C13B 10/06

(57) ABSTRACT

The present invention belongs to the field of mechanical engineering and materials, more specifically in the metallurgy segments, for application in the sugar industry. The invention relates to the hot forging process of mill shafts and heat-treated auxiliary equipment in CrNiMo and low carbon alloy. The shafts and auxiliary equipment manufactured according to this invention have a long service life, thus reducing downtime for maintenance and increasing reliability, since it eliminates the problems associated with cracks and instantaneous fractures. As a consequence, there is a reduction in the risks of accidents and production losses associated with stoppages.

### FIELD OF THE INVENTION

This document belongs to the field of mechanical engineering and materials, for application in the sugar industry. It consists of the manufacture of shafts of different dimensions and auxiliary equipment, more specifically for the manufacture of shafts for sugar cane mills, from a low alloy steel based on Chromium, Nickel and Molybdenum, hot forged and heat treated by the method of normalization and quenching+tempering. The shafts and auxiliary equipment manufactured according to the steel alloy of this document and according to the heat treatments of this document present high mechanical resistance, resulting in greater reliability of the shafts and auxiliary equipment in operation, with a long useful life and better productivity, when compared to the state of the art.

### STATE OF ART DESCRIPTION

U.S. Pat. No. 4,765,550 deals with a modified mill spindle, with wider openings for the passage of extracted juice, contemplating not only the milling of sugar cane but any succulent material, provided that the juice extraction process is done by pressing such material. The spindle is composed of a shaft (11) and a cylindrical casing of the shaft (12), this casing consisting of a plurality of channels (13) for the passage of the extracted juice. The shaft is manufactured using material common to the state of the art, its composition not being specified in the document. The presented shaft does not undergo a special heat treatment, thus not having its mechanical properties optimized. The shaft produced according to the ACF130 alloy presents high durability, resulting in high reliability in the shaft in use.

U.S. Pat No. 4,391,026 discloses a mill roll composed of a roll body, a plurality of circumferentially extending grooves formed at the periphery of the roll body, a plurality of channels extending axially through the roll body at positions into the grooves, a plurality of inserts mounted within the roller body at the radial bottoms of the grooves, and each insert extending substantially radially through an opening connecting the respective groove with a respective channel. A milling spindle (10) is shown with a lower roller (12) and an upper roller (18) for pressing the succulent material. The juice is captured through juice channels (16) arranged along the upper roller (18). The upper roll (18) is composed of a shaft (30) and a casing (28), which can be formed separately or integrally (28). The mill roll is manufactured using steel alloys present in the state of the art, without using a manufacturing process specifically carried out to optimize the mechanical properties of the shaft and auxiliary components.

U.S. Pat. No. 3,969,802 presents a milling spindle for extracting juice from succulent material, such as sugar cane, with optimized draining of the extracted juice. In addition to the juice channels (6) originally present in the milling spindles, document U.S. Pat. No. 3,969,802 presents the surface of the upper roller (1) with V-grooves (10) and a plurality of holes (4), extending from the surface of the roller to internal channels (3). These grooves, associated with the internal channels, optimize the process of collecting the juice extracted from the succulent material. There is, however, no presentation of the material that makes up the shaft, just as there is no claim covering heat treatments carried out on the shaft produced to optimize mechanical properties.

Document CN209175428 presents equipment for milling sugarcane. The equipment is optimized in order to present greater stability during operation, thus extending the useful life of the rolling. Furthermore, greater stability during use leads to superior product quality. However, patent CN209175428 does not present claims regarding the production process of the milling shaft, nor does it claim the material that composes it.

### SUMMARY OF THE INVENTION

The present invention claims the process of forging mill shafts and auxiliary equipment manufactured in Chromium-Nickel-Molybdenum alloy and low carbon steel, ACF130, for application in the sugar industry. Alloy ACF130 presents the following chemical composition in mass percentage: 0.28 to 0.33% of C; 0.50 to 0.60% of Mn; 0.15 to 0.35% of Si; 0.80 to 1.10% of Cr; 0.15 to 0.25% of Mo; 0.35 to 0.50% of Ni; an amount of less than 0.025% of P; an amount of less than 0.025% of S; an amount of less than 0.35% of Cu; an amount of less than 0.35% of V; and a maximum of 3.0 PPM of H.

The present invention also claims the application of the ACF130 alloy in the manufacture of gears, shafts, screws, beams, and machine parts, as well as in the manufacture of shafts for sugar cane mills and auxiliary equipment.

The present invention also claims the shafts for sugar cane mills manufactured according to low alloy steel ACF130, whose composition in mass percentage is given by 0.28 to 0.33% of C; 0.50 to 0.60% of Mn; 0.15 to 0.35% of Si; 0.80 to 1.10% of Cr; 0.15 to 0.25% of Mo; 0.35 to 0.50% of Ni; an amount of less than 0.025% of P; an amount of less than 0.025% of S; an amount of less than 0.35% of Cu; an amount of less than 0.35% of V; and a maximum of 3.0 PPM of H.

The shafts claimed in the present invention are hot forged, in a 2500 Ton press, with an area reduction ratio greater than 3:1.

The shafts claimed in the present invention undergo a heat treatment process of normalization, quenching and tempering.

The heat treatment for normalizing the shafts claimed in the present invention is carried out with heating at a temperature higher than the austenitizing temperature (860 to 890° C.), with an average heating rate of 80° C./h, in electric or natural gas furnaces, being kept at austenitizing temperature for a minimum period of 0.5 h/inch shaft thickness. Subsequently, the shafts are cooled in still air to room temperature.

The tempering heat treatment of the shafts claimed in the present invention is carried out by reheating the normalized shafts to a temperature higher than the austenitizing temperature (870 to 910° C.), with an average heating speed of 80° C./h, in electric or natural gas furnaces, being maintained at the austenitizing temperature for a minimum period of 0.5 h/inch of shaft thickness. Subsequently, the shafts are cooled by water in a 130,000-liter tank and agitated by pumps and compressed air.

The tempering treatment of the shafts claimed in the present invention is carried out by reheating the normalized and tempered shafts to a temperature between 620 and 660° C., with an average heating speed of 80° C./h, in electric or natural gas furnaces, being kept at the heating temperature for a minimum of 0.75 h/inch shaft thickness. Subsequently, the shafts are cooled in still air to room temperature.

### OBJECTIVES OF THE INVENTION

The shafts and auxiliary equipment that make up sugarcane milling equipment require both predictive and corrective maintenance procedures, due to numerous factors, highlighting the presence of cracks, usually identified in the sugarcane off-season during predictive maintenance, and the instantaneous rupture of the shaft in operation, due to the fatigue of operation. In the case of shallow cracks, these are normally eliminated by sanding, recomposed by means of welding and submitted to a new machining process.

The aforementioned problems result in high maintenance costs, due to preventive stops followed by the recovery process by welding+machining, interruptions in production, low reliability of the shafts in operation and risks of accidents with operators.

Milling shafts manufactured as specified in this document have a long service life and greater resistance to fatigue and traction, resulting in reduced downtime and maintenance costs and increased reliability of the shaft in operation. As a consequence, the use of milling shafts manufactured in accordance with this document provides greater operational safety and reduces the risk of accidents with operators, in addition to reducing production losses. Therefore, the present invention is provided with industrial applicability.

### DETAILED DESCRIPTION OF THE INVENTION

The present invention refers to the forging of mill shafts and auxiliary equipment, for use in the sugar cane industry. The shafts are manufactured using a low carbon steel alloy based on Chromium-Nickel-Molybdenum, hot forged in a 2500 Ton press with an area reduction ratio greater than 3:1, heat treated (normalization, quenching and tempering) for hardness ranges between 200 and 250 HB and tensile strength greater than 620 Mpa, yield strength greater than 380 Mpa and impact strength greater than 80 J at room temperature.

The ACF130 alloy is specially modified to present high mechanical properties compared to the state of the art, increasing the reliability of the shafts in operation and reducing the necessary stops for predictive maintenance. The manufacturing process presented in the invention provides parts with high tensile strength and good hardness, reducing the occurrence of damage due to use, especially cracks and mechanical fatigue.

Alloy ACF130 presents the following chemical composition in mass percentage: 0.28 to 0.33% of C; 0.50 to 0.60% of Mn; 0.15 to 0.35% of Si; 0.80 to 1.10% of Cr; 0.15 to 0.25% of Mo; 0.35 to 0.50% of Ni; an amount of less than 0.025% of P; an amount of less than 0.025% of S; an amount of less than 0.35% of Cu; an amount of less than 0.35% of V; and a maximum of 3.0 PPM of H.

Hot forging with a reduction ratio greater than 3:1 ensures that the shafts are free from internal defects. Hot forging is carried out in a press with a capacity of 2500 Ton.

The normalization heat treatment aims to homogenize and refine the steel microstructure, in order to better receive the subsequent thermal treatments. Normalization is carried out by fully heating the shafts in an electric or natural gas furnace, at an average heating speed of 80° C./h, at a temperature higher than that of austenitization, between 860 and 890° C. The permanence time of the pieces in the furnace depends on the diameter of the shaft to be manufactured, with this permanence time in the furnace being 0.5 h/inch of shaft diameter. The shafts are cooled slowly by still air to room temperature.

The improvement of the shafts (heat treatment of quenching+tempering) aims to obtain sufficient tensile strength to support the workloads, guaranteeing optimized mechanical properties, meeting the solution of the problems identified in the state of the art. Quenching is carried out by heating the shafts to a temperature higher than the austenitizing temperature, between 870 and 910° C., in an electric or natural gas furnace, at an average heating rate of 80° C./h. The permanence time of the pieces in the furnace depends on the diameter of the forged shafts, with this permanence time in the furnace being 0.5 h/inch of shaft diameter. The shafts are cooled in a tank holding 130,000 liters of water and stirred by pumps and compressed air, to a temperature of less than 150° C. Tempering is carried out by heating the shafts to a temperature between 620 and 660° C., to meet the specified hardness range. Heating is carried out in an electric or natural gas oven, at an average heating speed of 80° C./h. The permanence time of the pieces in the oven depends on the diameter of the forged shafts, this time being 0.75 h/inch of shaft diameter. The cooling of the shafts after tempering is carried out by convection, in still air, to room temperature.

1. Low alloy steel based on Chromium-Nickel-Molybdenum, characterized in that it comprises the following chemical composition in mass percentage: 0.28 to 0.33% C; 0.50 to 0.60% Mn; 0.15 to 0.35% Si; 0.80 to 1.10% Cr; 0.15 to 0.25% Mo; 0.35 to 0.50% Ni; an amount of less than 0.025% of P; an amount of less than 0.025% of S; an amount of less than 0.35% of Cu; an amount of less than 0.35% of V; and a maximum of 3.0 PPM of H.

2. Low alloy steel based on Chromium-Nickel-Molybdenum, as in claim 1, wherein it is applicable to manufacture of gears, shafts, screws, beams, and machine parts.

3. Low alloy steel based on Chromium-Nickel-Molybdenum, as in claim 1, wherein it is applicable to manufacture shafts for sugar cane mills and auxiliary equipment.

4. Shafts for sugar cane mills characterized in that the mill shafts are manufactured according to the low alloy steel as described in claim 1.

5. Shafts for sugar cane mills, as in claim 4, wherein the mill shafts are hot forged, in a 2500 Ton press, with an area reduction ratio greater than 3:1.

6. Shafts for sugar cane mills, as in claim 4, wherein the mill shafts undergo a normalization treatment, with austenitization temperature of 860 to 890° C.

7. Shafts for sugar cane mills, as in claim 6, wherein the mill shafts undergo a normalization treatment, with an average heating speed of 80° C./h, in electric or natural gas furnaces, being maintained at austenitization temperature for a minimum period of 0.5 h/inch of shaft thickness.

8. Shafts for sugar cane mills, as in claim 7, wherein the mill shafts undergo a normalization treatment, being cooled to room temperature in still air.

9. Shafts for sugar cane mills, as in claim 6, wherein the mill shafts undergo a quenching treatment, with austenitization temperature of 870 to 910° C.

10. Shafts for sugar cane mills, as in claim 9, wherein the mill shafts undergo a quenching treatment, with an average heating speed of 80° C./h, in electric or natural gas furnaces, being kept at the austenitizing temperature for a minimum period of 0.5 h/inch of shaft thickness.

11. Shafts for sugar cane mills, as in claim 10, wherein the mill shafts undergo a quenching treatment, being cooled down to a temperature below 150° C., with cooling carried out by water in a tank with 130,000 liters and with agitation by pumps and compressed air.

12. Shafts for sugar cane mills, as in claim 11, wherein the mill shafts undergo a quenching treatment, with heating up to a temperature between 620 and 660° C.

13. Shafts for sugar cane mills, as in claim 12, wherein the mill shafts undergo a quenching treatment, with an average heating speed of 80° C./h, in electric or natural gas furnaces, being kept at the heating temperature for a minimum time of 0.75 h/inch of shaft thickness.

14. Shafts for sugar cane mills, as in claim 13, wherein the mill shafts undergo a quenching treatment, being cooled to room temperature in still air.
